(19) United States
(12) Patent Application Publication
(10) Pub. No.: US 2025/0178509 A1
(43) Pub. Date: Jun. 5, 2025

(54) VEHICLE WITH CUP HOLDERS

(71) Applicant: KAWASAKI MOTORS, LTD., Akashi-Shi (JP)

(72) Inventors: Kota HIDAKA, Akashi-Shi (JP); Hidefumi YASUHARA, Akashi-Shi (JP)

(73) Assignee: KAWASAKI MOTORS, LTD., Akashi-Shi (JP)

(21) Appl. No.: 18/526,097

(22) Filed: Dec. 1, 2023

(51) Int. Cl. B60N 3/10; B62D 1/04; B62D 1/16; B62D 25/14

(52) U.S. Cl. CPC B60N 3/101; B62D 1/04; B62D 1/16; B62D 25/14

(57) ABSTRACT

A vehicle includes: a car body; wheels rotatably supported by the car body; a steering wheel steering the wheels; a seat more rearward than the steering wheel; and a dashboard including a dashboard body, a left cup holder, and a right cup holder. The dashboard body is more forward than the seat, the left cup holder is located to the left of a middle in a vehicle-width direction, and the right cup holder is located to the right of the middle in the vehicle-width direction.

### FIELD OF THE INVENTION

The present disclosure relates to a vehicle with cup holders.

### BACKGROUND ART

U.S. Pat. No. 7,413,244B2 discloses a utility vehicle including a front fender equipped with container holders.

U.S. Pat. No. 6,321,960B1 discloses a system attached to a dashboard and including a rail to which a cup holder is attached.

### SUMMARY

A vehicle includes: a car body; wheels rotatably supported by the car body; a steering wheel steering the wheels; a seat more rearward than the steering wheel; and a dashboard including a dashboard body, a left cup holder, and a right cup holder, the dashboard body being more forward than the seat, the left cup holder being located to the left of a middle in a vehicle-width direction, the right cup holder being located to the right of the middle in the vehicle-width direction.

In this vehicle, the occupant to be seated to the left of the seat can use the left cup holder in front of the seat, and the occupant to be seated to the right of the seat can use the right cup holder in front of the seat, which is convenient.

The objects, features, aspects, and advantages of this disclosure will become more apparent from the following detailed description and the accompanying drawings.

### BRIEF DESCRIPTION OF THE DRAWINGS

FIG. 1 is a side view illustrating a vehicle.

FIG. 2 is a perspective view illustrating a dashboard.

FIG. 3 is a plan view illustrating the dashboard.

FIG. 4 is a plan view illustrating the dashboard.

FIG. 5 illustrates a cross section taken along the line V-V of FIG. 3.

### DESCRIPTION OF THE PREFERRED EMBODIMENTS

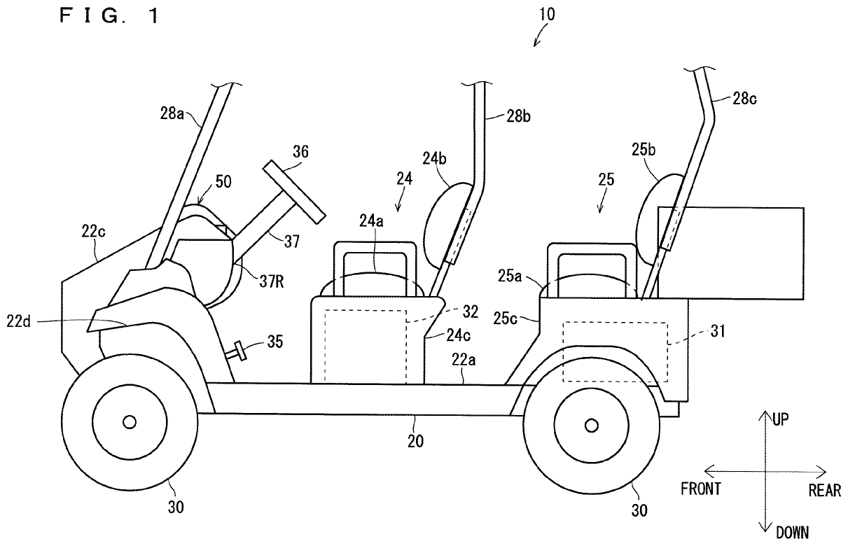

A vehicle with cup holders according to an embodiment will be hereinafter described. FIG. 1 is a side view illustrating a vehicle 10. In the following description, traveling directions of the vehicle 10 may be expressed as forward, backward opposite to the forward direction, downward toward road surfaces on which the vehicle 10 travels, and upward opposite to the downward direction. The right and left may be referred to while a person stands on a road surface and faces forward. The lateral direction is a vehicle-width direction.

The vehicle 10 may be an occupant transport vehicle designed to travel at low speeds within a limited area.

The vehicle 10 may be, for example, an off-road vehicle. The off-road vehicle may be a versatile small vehicle suitable for off-road travel rather than for fast travel on a public road.

Examples of the off-road vehicle include a side-by-side vehicle. The side-by-side vehicle is, for example, a small vehicle suitable for all terrain travel, and a vehicle in which occupants can be seated side by side. The side-by-side vehicle may be, for example, a multipurpose off-highway utility vehicle (MOHUV) defined by ANSI/OPEI B71.9-2016, and a recreational off-highway vehicle defined by ANSI/ROHVA 1-2016.

Examples of the limited area may include limited community areas, private roads, and private lands (e.g., golf courses and parks). The limited community areas are areas provided for use by community residents. The community areas are, for example, areas including houses and public facilities (e.g., schools and hospitals), and are areas in which the vehicle 10 designed to travel through non-public highways are permitted to travel at low speeds. The low speeds are, for example, speeds with upper limits ranging from 20 mph to 30 mph. Examples of the vehicle 10 include personal transport vehicles (PTVs) in accordance with ANSI/ILTVA Z135, and golf carts in accordance with ANSI/ILTVA Z130.1. The examples of the vehicle include personal transportation electric vehicles.

The vehicle 10 may be a vehicle in which at least two occupants can ride side by side. The vehicle 10 may be opened outside of seats 24 and 25 in a vehicle-width direction without being obstructed by walls or doors to facilitate the occupants getting on or off the vehicle 10. Here, the occupants can walk past in a lateral direction without being obstructed by doors or walls.

The vehicle 10 includes a car body 20, wheels 30, a steering wheel 36, the seats 24 and 25, and a dashboard 50.

The car body 20 may have a frame structure or a monocoque structure. For example, when the car body 20 has a frame structure, the car body 20 includes a frame and panels. The frame is structured by combining, for example, metallic pipe components, sheet metal components, or cast components. The panels cover the frame and various components supported by the frame. The panels give the appearance of the vehicle 10, and partition spaces in the vehicle 10. Examples of the panels include a floor panel 22a, the dashboard 50, a hood 22c, and fenders 22d. The floor panel 22a is located at the bottom of the space for occupants. The dashboard 50 is more forward than the seats 24 and 25. The hood 22c is more forward than the dashboard 50. The hood 22c externally covers a support mechanism of the front wheels 30. The fenders 22d are located at outside portions of the hood 22c in the lateral direction, and cover the front wheels from above with some space.

Each of the seats 24 and 25 is a part on which an occupant is to be seated. The seats 24 and 25 are located on the floor panel 22a and behind the dashboard 50. The car body 20 supports the seat 25 on the floor panel 22a.

The seats 24 and 25 are spaced apart from each other in the forward and backward direction. The seat 24 is more forward than the seat 25.

The seat 24 includes a seat cushion 24a, a back rest cushion 24b, and a seat base 24c. The seat base 24c supports the seat cushion 24a at a position away from the floor panel 22a. The back rest cushion 24b is supported in an upright attitude behind the seat cushion 24a. The dashboard 50, which is more forward than the seat 24, faces the seat 24. The occupant seated on the seat 24 is accessible to at least a back portion of the dashboard 50.

The seat 24 is a seat on which at least two occupants can be seated side by side. In this case, the seat cushion 24a may be continuous in the vehicle-width direction, or separated in the middle in the lateral direction. This embodiment describes an example where the seat cushion 24a is a bench seat continuous in the vehicle-width direction. The back rest cushion 24b may also be continuous in the vehicle-width direction, or separated to the right and left.

Similarly, the seat 25 includes a seat cushion 25a, a back rest cushion 25b, and a seat base 25c. The seat base 25c supports the seat cushion 25a at a position away behind the seat 24 and above the floor panel 22a. The occupant can be seated on the seat cushion 25a while the feet are placed between the seat cushions 24a and 25a.

The seat 25 may be a bench seat or separated to the right and left. The back seat 25 may be omitted. The back seat 25 may consist of seats in the forward and backward direction.

Outside portions of the seats 24 and 25 in the vehicle-width direction are openings through which occupants get on or off the vehicle 10. The vehicle 10 is intended to normally travel with the openings being opened and not closed by, for examples, doors.

The wheels 30 are supported by the car body 20 to be rotatable. The four wheels 30 are located, for example, at four corners of the car body 20. The wheels 30 support the car body 20 on a road surface. The rotation of the wheels 30 on a road surface enables the car body 20 to travel on the road surface. The number of the wheels 30 is discretionary. The vehicle may be, for example, a three-wheel vehicle or a six-wheel vehicle.

A travel driving mechanism should rotationally drive the wheels 30. The travel driving mechanism includes a traveling motor 31 and a power transmission mechanism. Transmission of rotation drive force of the traveling motor 31 to the wheels 30 through the power transmission mechanism allows the vehicle 10 to travel.

The structure of the power transmission mechanism is discretionary. Examples of the power transmission mechanism may include a transmission and a drive shaft. The power transmission mechanism may drive only the rear wheels, only the front wheels, or all the wheels.

The two front wheels 30 are rotatable around its own central axis and are supported to be rotatable around a steering axis, at right and left front portions of the car body 20. The two rear wheels 30 are supported to be rotatable around its own central axis at right and left rear portions of the car body 20.

In this embodiment, the traveling motor 31 is an electric motor that converts electric energy into rotational motion for traveling. Here, the occupant transport vehicle 10 includes a traveling battery 32 for supplying the electric energy to the traveling motor 31. For example, the traveling battery 32 is supported at a lower portion of the seat 24, and the traveling motor 31 is supported at a lower portion of the seat 25. As described in this embodiment, the vehicle 10 for transporting occupants which includes the traveling motor 31 that is an electric motor is an electric occupant transport vehicle. The traveling motor 31 may be an internal combustion engine that burns fuel in a combustion chamber and generates power for traveling through expansion of gases from the burnt fuel. Here, the occupant transport vehicle should include a fuel tank. The positions of the traveling motor 31 and the traveling battery 32 are discretionary.

The steering wheel 36 is a steering wheel for steering the wheels 30. In this embodiment, the steering wheel 36 steers the front wheels 30. The steering wheel may steer the rear wheels, or the front and rear wheels.

The steering wheel 36 is a steering wheel for receiving a driving operation from the driver. The steering wheel 36 may be, for example, shaped like a ring. The steering wheel 36 is supported to be rotatable by a steering column 37. The steering wheel 36 is supported at a position behind the dashboard 50. Thus, the seat 24 is more rearward than the steering wheel 36. The steering wheel 36 is supported at a position displaced to one of the right and the left with respect to the middle in the vehicle-width direction.

This embodiment describes an example where the vehicle 10 is a left-steering vehicle in which the driver is seated on the left. Thus, the steering wheel 36 is supported at a position displaced to the left with respect to the middle in the vehicle-width direction. The driver seated to the left of the front seat 24 can operate the steering wheel 36.

The rotation operation of the steering wheel 36 is transmitted to the front wheels 30 via, for example, the steering column 37 and a rack and a pinion. This can steer the wheels 30 in both the right and the left directions. The steering column 37 may include a switch or a display.

Pedals 35 are located below the steering wheel 36. The pedals 35 are, for example, an accelerator pedal and a brake pedal. The pedals 35 may be an accelerator pedal and a brake pedal that are separately provided. The number of the pedals 35 may be one that receives both operations of an accelerator and a brake.

The dashboard 50 is more forward than the seat 24 on which the driver is to be seated, and is more forward than the steering wheel 36. The frame structure of the car body 20 and a support structure and wiring parts of the front wheels 30 are disposed in front of the dashboard 50. The support structure of the wheels 30 is, for example, the rack and the pinion for steering and a suspension. The dashboard 50 can function as a partition between an area for occupants to be seated on the seat 24, and the frame structure, the support structure, and the wiring parts.

The vehicle 10 may include pillars 28a, 28b, and 28c. The pillars 28a, 28b, and 28c are pillars supported upright by the car body 20. The pillar 28a, the pillar 28b, and the pillar 28c may include two right and left front pillars 28a, two right and left center pillars 28b, and two right and left rear pillars 28c, respectively.

The two right and left front pillars 28a are the pillars 28a rising upward through outside positions of the dashboard 50 in the vehicle-width direction. The two right and left front pillars 28a may rise upward through outside front portions of the dashboard 50 in the vehicle-width direction. The two right and left front pillars 28a may rise upward to lean rearward at positions above the dashboard 50. A front windshield may be supported between the two right and left front pillars 28a.

The front pillars 28a may be more rearward than the hood 22c. The right and left floor panel 22a and the front windshield may be located along a boundary between the hood 22c and the dashboard 50.

The two right and left rear pillars 28c rise upward from a rear portion of the car body 20. The two right and left rear pillars 28c rise upward, for example, via behind the back rest cushion 25b.

The two right and left center pillars 28b are located between the front pillars 28a and the rear pillars 28c in the forward and backward direction. The two right and left rear pillars 28c rise upward, for example, via behind the back rest cushion 24b.

The front pillars 28a, the center pillars 28b, and the rear pillars 28c may be referred to as A pillars, B pillars, and C pillars, respectively.

The pillars 28a, 28b, and 28c may support a roof or a top frame. The number and positions of the pillars 28a, 28b, and 28c are discretionary. For example, the center pillars 28b may be omitted.

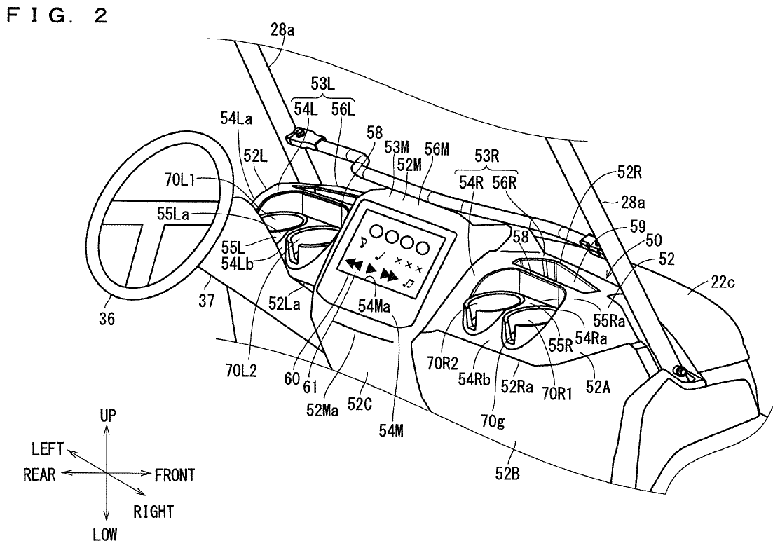

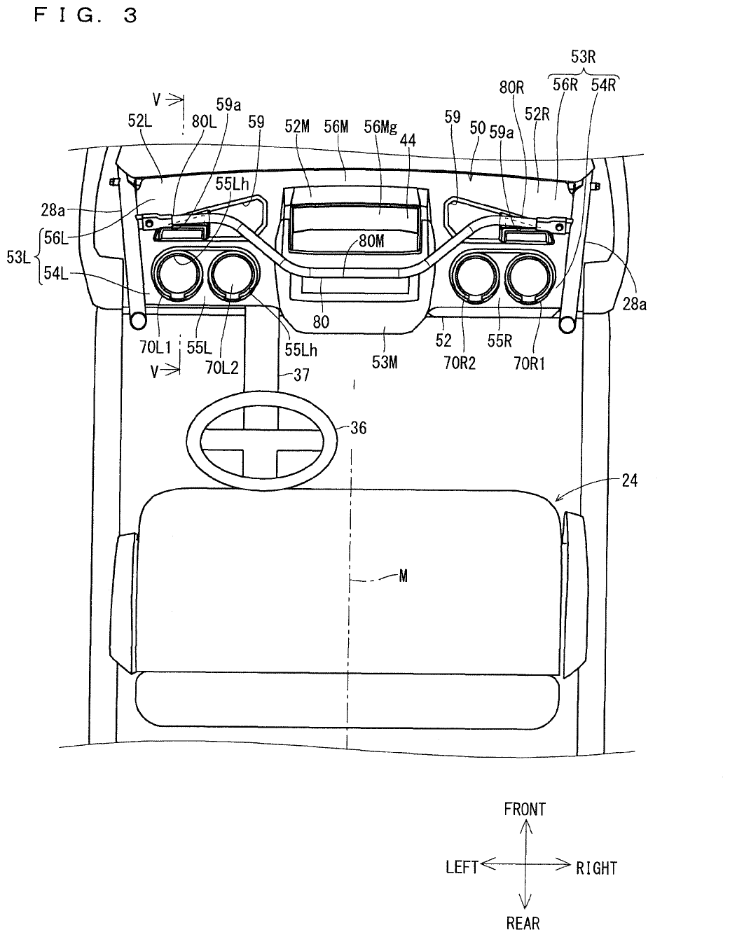

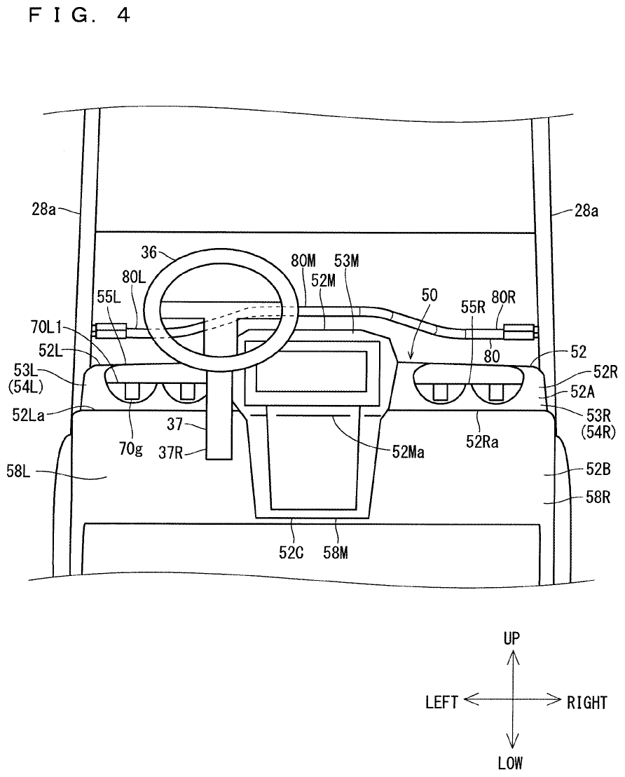

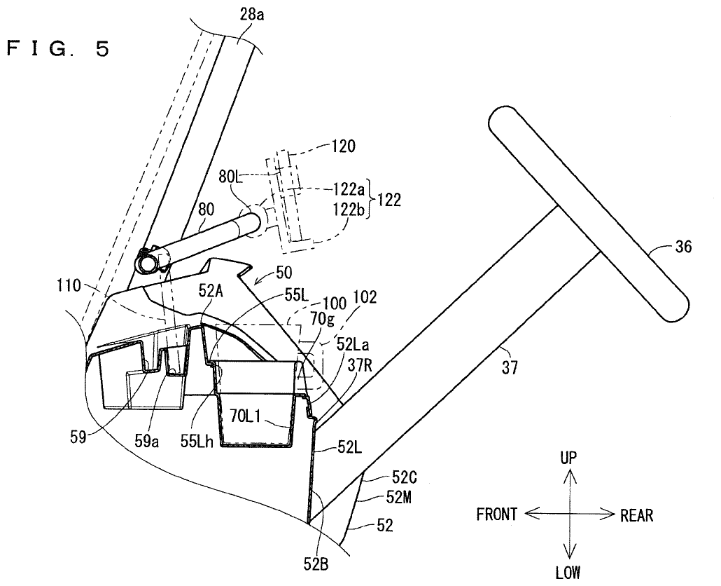

The dashboard 50 will be described. FIG. 2 is a perspective view illustrating the dashboard 50. FIG. 3 is a plan view illustrating the dashboard 50. FIG. 4 is a plan view illustrating the dashboard 50. FIG. 5 illustrates a cross section taken along the line V-V of FIG. 3.

The dashboard 50 includes a dashboard body 52, left cup holders 70L1 and 70L2, and right cup holders 70R1 and 70R2.

The dashboard body 52 is more rearward than the front wheels 30 and the support mechanism of the front wheels 30. The dashboard body is more rearward than the hood 22c. The dashboard body 52 is more forward than the front seat 24. The dashboard body 52 can partition the front wheels 30 and the support mechanism of the wheels 30, and the space for the occupants to be seated on the front seat 24.

The dashboard body 52 may include a left portion 52L, a middle portion 52M, and a right portion 52R. One of the left portion 52L and the right portion 52R is a portion closer to the steering wheel 36 in the vehicle-width direction, that is, a portion in front of the driver. In this embodiment, the left portion 52L is the portion in front of the driver.

The right portion 52R is a portion in front of an occupant to be seated next to the driver. The middle portion 52M is a portion in the middle of the dashboard body 52 in the vehicle-width direction, that is, a portion between the driver and the occupant.

The left portion 52L in a side view includes a curved portion whose middle portion bulges the most rearward in the vertical direction. In a side view of the left portion 52L, a portion of the left portion 52L which protrudes the most rearward is an edge 52La. The edge 52La extends along the vehicle-width direction.

An upper portion of the left portion 52L with respect to the edge 52La is a left upper portion 53L, and a lower portion of the left portion 52L with respect to the edge 52La is a left lower portion 58L.

The left upper portion 53L includes a sloped portion 54L facing diagonally upward and rearward, and a front portion 56L facing upward. The sloped portion 54L extends diagonally upward and forward from the edge 52La. In other words, the sloped portion 54L faces the face of the occupant to be seated on the seat 24. The front portion 56L extends forward from an edge opposite to the edge 52La in the sloped portion 54L. The front portion 56L has an attitude more horizontal than the sloped portion 54L, and may have a horizontal attitude. In this embodiment, the front portion 56L is sloped diagonally downward toward the front. The hood 22c is more forward than the front portion 56L. The front windshield partitions the space above the front portion 56L and the space above hood 22c.

A cup placement portion 55L is formed in the sloped portion 54L. The cup placement portion 55L is formed in a middle portion of the sloped portion 54L in the vehicle-width direction and the forward and backward direction. The cup placement portion 55L spreads to a region to the extent that cups can be placed in a plan view. For example, the cup placement portion 55L spreads to a region in which two cups can be placed side by side.

The cup placement portion 55L includes a bottom portion 55La along the horizontal direction. For example, a front portion of the cup placement portion 55L is partially recessed with respect to the sloped portion 54L. A rear portion of the cup placement portion 55L is partially tubular and protrudes from the sloped portion 54L. A combination of the partial recessed portion with respect to the sloped portion 54L and the partially tubular portion forms the bottom portion 55La with a support surface extending along the horizontal direction.

Since the front portion of the cup placement portion 55L is partially recessed with respect to the sloped portion 54L, a vertical wall 54La protruding upward from the bottom portion 55La is located in front of the cup placement 55L and outside of the cup placement portion 55L on both sides.

Since the rear portion of the cup placement portion 55L is tubular and partially protrudes from the sloped portion 54L, a sloped surface 54Lb of the sloped portion 54L is more forward than the cup placement portion 55L. The sloped surface 54Lb is a surface lower than openings of the left cup holders 70L1 and 70L2, and sloped more downward as it extends rearward.

The left lower portion 58L extends diagonally downward and forward from the edge 52La. The space in which the feet of the occupant are placed is formed under the left lower portion 58L.

The left portion 52L and the right portion 52R may be symmetric with respect to a middle M in the vehicle-width direction. The middle M is, for example, a surface in the direction of gravity which passes through the middle between the right front wheel and the left front wheel and the middle between the right rear wheel and the left rear wheel.

Thus, the right portion 52R may include a right upper portion 53R, an edge 52Ra, and a right lower portion 58R, similarly to the left portion 52L. Furthermore, the right upper portion 53R may include a sloped portion 54R and a front portion 56R, and the sloped portion 54R may include a cup placement portion 55R with a bottom portion 55Ra, a vertical wall 54Ra, and a sloped surface 54Rb, similarly to the left upper portion 53L.

The left portion 52L and the right portion 52R need not be symmetric. For example, the sloped portions 54L and 54R need not have the same slope angle or the same shape in spreading portions thereof.

The middle portion 52M is located between the left portion 52L and the right portion 52R. A proportion of the middle portion 52M to the dashboard body 52 is discretionary. FIG. 3 illustrates an example where the left portion 52L, the middle portion 52M, and the right portion 52R account for the respective regions obtained by dividing the dashboard body 52 into three equal parts in the vehicle-width direction.

The middle portion 52M in a side view includes a curved portion which protrudes more than the left portion 52L and the right portion 52R and whose middle portion bulges the most rearward in the vertical direction. In a side view of the middle portion 52M, a portion of the middle portion 52M which protrudes the most rearward is an edge 52Ma. The edge 52Ma extends along the vehicle-width direction.

An upper portion of the middle portion 52M with respect to the edge 52Ma is a middle upper portion 53M, and a lower portion of the middle portion 52M with respect to the edge 52Ma is a middle lower portion 58M.

The middle upper portion 53M includes a sloped portion 54M facing diagonally upward and rearward, and a front portion 56M facing upward. The sloped portion 54M extends diagonally upward and forward from the edge 52Ma.

The sloped portion 54M protrudes more than the sloped portions 54L and 54R located to the right and left outside the sloped portion 54M. An opening 54Ma into which an information device 60 can be incorporated is formed in the sloped portion 54M. The information device 60 incorporated into the sloped portion 54L faces diagonally upward and rearward. Since the information device faces diagonally upward and rearward with respect to the edge 52Ma, the information device is easily seen and operated by both of the driver and the occupant.

The information device 60 may be an apparatus that can display information and can be operated. The information device 60 may be, for example, an apparatus including a touch panel 61 that displays information and receives a touch operation. The information device 60 may be, for example, an entertainment information device such as audio equipment, or a navigation apparatus. The audio equipment may be, for example, an apparatus including an amplifier circuit and operation functions for playing back music. The information device 60 may be connectable to an external apparatus possessed by the occupant. For example, a smart phone or a tablet terminal may be connected to the information device 60 through a USB cable or via Bluetooth.

The middle portion 52M may include switches for operating the respective units of the vehicle 10. The middle portion 52M may include, for example, switches for switching various lights of the vehicle 10 and switches for changing emission directions of the lights.

The front portion 56M extends forward from an edge opposite to the edge 52Ma in the sloped portion 54M. The front portion 56M protrudes more than the front portions 56L and 56R. A housing recess 56 Mg opening upward may be formed in the front portion 56M. The front portion 56M is located between the front portions 56L and 56R. The hood 22c is more forward than the front portion 56M. The front windshield partitions the space above the front portion 56M and the space above hood 22c.

The middle lower portion 58M extends diagonally downward and forward from the edge 52Ma. The middle lower portion 58M protrudes more than the left lower portion 58L and the right lower portion 58R. The space in which the feet of the occupant are placed is formed under the middle lower portion 58M. Since the space in which the feet of the occupants can be placed is formed continuously under the left lower portion 58L, the middle lower portion 58M, and the right lower portion 58R in the vehicle-width direction, the occupants easily get on or off the vehicle 10. Particularly, since a portion for disposing a drink holder need not be formed in a lower portion of the middle lower portion 58M, an empty space under the middle lower portion 58M can be reserved wide.

The middle portion 52M may be omitted, and the left portion 52L and the right portion 52R may be directly connected.

The dashboard body 52 may be a combination of components, or a single component. In this embodiment, the dashboard body 52 includes an upper dashboard body 52A, and a lower dashboard body 52B under the upper dashboard body.

The upper dashboard body 52A is obtained by integrally molding front portions of the left upper portion 53L, the right upper portion 53R, and the front portion 56M using a resin. The lower dashboard body 52B is obtained by integrally molding the left lower portion 58L, the right lower portion 58R, and the front portions of the middle lower portion 58M using a resin.

A portion of the middle portion 52M except the portions integrated into the upper dashboard body 52A and the lower dashboard body 52B may be molded as a middle dashboard body 52C, separately from the upper dashboard body 52A and the lower dashboard body 52B.

In other words, the left portion 52L has a structure divided into the left upper portion 53L and the left lower portion 58L by the edge 52La. The right portion 52R has a structure divided into the right upper portion 53R and the right lower portion 58R by the edge 52Ra. Furthermore, the left upper portion 53L and the right upper portion 53R are integrally formed by connection through an upper front portion of the middle portion 52M. Since the cup placement portions 55L and 55R are formed in the upper dashboard body 52A, the upper dashboard body 52A includes the left cup holders 70L1 and 70L2 in the cup placement portion 55L and the right cup holders 70R1 and 70R2 in the cup placement portion 55R. Furthermore, the left lower portion 58L and the right lower portion 58R are integrally formed by connection through a lower front portion of the middle portion 52M. The middle portion 52M is incorporated into a middle region enclosed by the upper dashboard body 52A and the lower dashboard body 52B.

The upper dashboard body 52A, the lower dashboard body 52B, and the middle dashboard body 52C are joined together so that the respective mating surfaces are closed, and supported by the frame of the car body 20.

When a dashboard body is structured from a combination of components, the divided structure is not limited to the aforementioned example. For example, the middle dashboard body 52C may be integrally formed into the upper dashboard body 52A or the lower dashboard body 52B.

The left cup holders 70L1 and 70L2 are located to the left of the middle M in the vehicle-width direction, and the right cup holders 70R1 and 70R2 are located to the right of the middle M in the vehicle-width direction.

Here, the left cup holders 70L1 and 70L2 are located in the cup placement portion 55L in the left upper portion 53L, and the right cup holders 70R1 and 70R2 are located in the cup placement portion 55R in the right upper portion 53R.

Specifically, per-set openings 55Lh are formed in the cup placement portion 55L. The per-set openings 55Lh are formed at positions corresponding to the number and the placement of the left cup holders 70L1 and 70L2. Here, the two per-set openings 55Lh are formed side by side in the vehicle-width direction. The cup placement portion 55L is opened as the per-set openings 55Lh at the bottom portion 55La.

The left cup holders 70L1 and 70L2 are each shaped like a cup with an opening at the top. Each of the left cup holders 70L1 and 70L2 may have a shape gradually spreading toward the top. Steps for changing an inner diameter through a difference in level may be formed in a middle portion of each of the left cup holders 70L1 and 70L2 in the vertical direction. Each of the left cup holders 70L1 and 70L2 may have a bottom. Although the openings of the left cup holders 70L1 and 70L2 are circular, they may be oval or polygonal. Although the left cup holders 70L1 and 70L2 have the same shape and size, they may have different shapes and sizes. The left cup holders 70L1 and 70L2 hold cups 100 at certain positions by inserting the cups 100 into the left cup holders 70L1 and 70L2.

An opening perimeter of each of the left cup holders 70L1 and 70L2 externally and annularly protrudes. The opening perimeters of the left cup holders 70L1 and 70L2 are in contact with the per-set openings 55Lh with the left cup holders 70L1 and 70L2 being inserted into the per-set openings 55Lh. This allows the left cup holders 70L1 and 70L2 to be supported by the per-set openings 55Lh in an insertion state. The left cup holders 7C0L1 and 70L2 are opened in this state at positions to be observed from above in a plan view.

The left cup holders 70L1 and 70L2 may be integrally formed into the dashboard body 52.

As described above, the front portion of the cup placement portion 55L is partially recessed with respect to the sloped portion 54L. The bottom portion 55La is located below the highest upper portion of the sloped portion 54L. The highest upper portion of the sloped portion 54L is a portion continuous from the sloped portion 54L to the front portion 56L and the top of the dashboard 50. Since the opening perimeters of the left cup holders 70L1 and 70L2 are located on the openings of the per-set openings 55Lh, the opening perimeters of the left cup holders 70L1 and 70L2 are located below the top of the dashboard 50.

As described above, the two right and left front pillars 28a rise upward through the outside front portions of the dashboard 50 in the vehicle-width direction. One of the front pillars 28a extends upward through the front portion 56L in a side view. The openings of the left cup holders 70L1 and 70L2 that are located in the sloped portion 54L are located more rearward than the front pillars 28a.

Each of the left cup holders 70L1 and 70L2 includes a recess 70g partially recessed downward from the opening perimeter. The recess 70g is formed with the width and the depth which allow a handle 102 of the cup 100 held by each of the left cup holders 70L1 and 70L2 to be disposed in the recess 70g.

The recess 70g may be located rearward in each of the opening perimeters of the left cup holders 70L1 and 70L2. The rearward in the perimeter means a rear position in the car body 20 with respect to the center of the opening perimeter. The recess 70g may be located the most rearward in each of the opening perimeters of the left cup holders 70L1 and 70L2. When the bottom portion 55La includes a partially tubular portion rising from the sloped portion 54L, a recess should be formed on the tubular portion at the same position as that of the recess 70g.

When the cups 100 each include the handle 102 as illustrated in FIG. 5, the cups 100 can be stably held by the left cup holders 70L1 and 70L2 with the handles 102 being disposed in the respective recesses 70g. The handles 102 may protrude outside the left cup holders 70L1 and 70L2 and the dashboard body 52 through the recesses 70g. This facilitates operations of placing the cups 100 in the left cup holders 70L1 and 70L2 or lifting the cups 100 from the left cup holders 70L1 and 70L2, while the occupants hold the handles 102.

The structures of the right cup holders 70R1 and 70R2 and the cup placement portion 55R are identical to those of the left cup holders 70L1 and 70L2 and the cup placement portion 55L. In other words, the left cup holders 70L1 and 70L2 include a first left cup holder 70L1 and a second left cup holder 70L2, and the right cup holders 70R1 and 70R2 include a first right cup holder 70R1 and a second right cup holder 70R2. Thus, each of the right and left occupants can use cup holders.

The numbers of the cup holders to be disposed to the right and the left are discretionary. For example, one cup holder may be disposed to the right, and two cup holders may be disposed to the left, two cup holders may be disposed to the right, and one cup holder may be disposed to the left, or three or more cup holders may be disposed to the right or the left.

Furthermore, the first left cup holder 70L1 and the second left cup holder 70L2 are aligned in the vehicle-width direction, and the first right cup holder 70R1 and the second right cup holder 70R2 are aligned in the vehicle-width direction. Thus, the left occupant is accessible to the first left cup holder 70L1 and the second left cup holder 70L2 under the same conditions, and the right occupant is accessible to the first right cup holder 70R1 and the second right cup holder 70R2 under the same conditions.

The placement of the cup holders is not limited to the examples above. The cup holders may diagonally be aligned in the forward and backward direction or the vehicle-width direction.

The left cup holders 70L1 and 70L2 are in symmetric alignment with the right cup holders 70R1 and 70R2 with respect to the middle M in the vehicle-width direction. Thus, the right and left occupants easily use cup holders in front of them under the same conditions.

The symmetric alignment between the left cup holders 70L1 and 70L2 and the right cup holders 70R1 and 70R2 with respect to the middle M in the vehicle-width direction is not essential. For example, a distance between one of the left cup holders and the middle may be larger than that between one of the right cup holders and the middle. The positions of the left cup holders may be displaced from those of the right cup holders forward and backward.

Since the cup placement portion 55L supports the left cup holders 70L1 and 70L2 and the cup placement portion 55R supports the right cup holders 70R1 and 70R2, the information device 60 is placed between the left cup holders 70L1 and 70L2 and the right cup holders 70R1 and 70R2. Thus, the right occupants and the left occupants easily use the left cup holders 70L1 and 70L2 and the right cup holders 70R1 and 70R2, respectively, and easily share the information device 60.

The dashboard body 52 includes support recesses 59a. The support recesses 59a are dents each supporting an external apparatus in a standing position. For example, a part of an external apparatus 110 is inserted into the support recess 59a. In this state, a bottom surface of the support recess 59a supports the lowest portion of the external apparatus 110, and a peripheral wall of the support recess 59a supports an upper portion of the lowest portion of the external apparatus 110. This supports the external apparatus 110 upright. The external apparatus 110 is, for example, a terminal that is not incorporated into the vehicle 10 and can be independently handled. Examples of the external apparatus 110 may include a smart phone, a tablet terminal, a foldable mobile phone, a wearable terminal, a camera, and a charging socket.

In this embodiment, storage trays 59 are formed in the front portion 56L in the left upper portion 53L, and in the front portion 56R in the right upper portion 53R. The storage trays 59 are partially recessed portions of the front portions 56L and 56R which are closer to the sloped portion 54L and 54R, respectively, and are formed as, for example, slim trays in the vehicle-width direction. The support recesses 59a are formed in portions of the storage trays 59 which are outside portions in the vehicle-width direction and are closer to the sloped portion 54L and 54R. The left support recess 59a is located behind the left cup holder 70L1 that is located more outward in the vehicle-width direction out of the left cup holders 70L1 and 70L2. Similarly, the right support recess 59a is located behind the right cup holder 70R1 located outward in the vehicle-width direction. In other words, each of the support recesses 59a is more forward than the left cup holders 70L1 and 70L2 or the right cup holders 70R1 and 70R2.

The support recesses 59a are slim dents in the vehicle-width direction, and opened upward. As illustrated in FIG. 5, the lowest portion of the external apparatus 110 with a rectangular flat shape is supported by the bottom surface of the support recess 59a, and leans against a front portion of the peripheral wall of the support recess 59a. This supports the external apparatus 110 upright.

The opening perimeters of the support recesses 59a are closer to surfaces of the front portions 56L and 56R which face upward. The opening perimeters of the left cup holders 70L1 and 70L2 and the right cup holders 70R1 and 70R2 are closer to the bottom portion 55La in the cup placement portion 55L and the bottom portion 55Ra in the cup placement portion 55R, respectively. Thus, the opening perimeter of each of the support recess 59a is located above the opening perimeters of the left cup holders 70L1 and 70L2 or the right cup holders 70R1 and 70R2. Thus, liquids in the cups 100 supported by the left cup holders 70L1 and 70L2 or the right cup holders 70R1 and 70R2 hardly splash onto the support recess 59a.

Furthermore, a partition wall 58 is located between the support recess 59a and the left cup holders 70L1 and 70L2, or between the support recess 59a and the right cup holders 70R1 and 70R2. The partition walls 58 are walls rising upward from the front portions of the cup placement portions 55L and 55R, and are along a direction vertical to the forward and backward direction. Thus, the partition walls 58 can exist above the openings of the cups 100 supported by the cup holders 70L1, 70L2, 70R1, and 70R2, and closer to the support recesses 59a. This allows the partition walls 58 to block the liquids spilling from the cups 100. Thus, the liquids hardly splash onto the support recesses 59a.

We focus on the cup holders located on the same side as the steering column 37, from among the left cup holders 70L1 and 70L2 and the right cup holders 70R1 and 70R2. Since the vehicle 10 is a left-steering vehicle in this embodiment, the left cup holders 70L1 and 70L2 are located closer to the steering column 37. When the vehicle 10 is a right-steering vehicle, the right cup holders are located closer to the steering column 37.

The left cup holders 70L1 and 70L2 are located more outward than the steering column 37 in the vehicle-width direction. This can prevent the cup holders from being located closer to the middle M in the vehicle-width direction than the steering column 37.

The central axis of the steering column 37 is referred to in the positional relationship in the vehicle-width direction. Thus, a part of the cup holder 70L2 closer to the middle in the vehicle-width direction may overlap the contour of the steering column 37. Furthermore, the steering wheel 36 may overlap the cup holder 70L2.

Furthermore, the opening perimeters of the left cup holders 70L1 and 70L2 and the right cup holders 70R1 and 70R2 may be located above a root 37R of the steering column 37 with respect to the dashboard 50. The steering column 37 itself reaches a steering mechanism such as a rack and a pinion which is located between the front wheels 30 through the dashboard 50. The root 37R is a portion at which the steering column 37 penetrates the dashboard 50. Locating the opening perimeters of the left cup holders 70L1 and 70L2 and the right cup holders 70R1 and 70R2 above the root 37R allows the occupants to easily visually recognize and handle the cups 100 held by the left cup holders 70L1 and 70L2 and the right cup holders 70R1 and 70R2.

The vehicle 10 may further include a holder 80 detachably holding an external apparatus 120 above the opening perimeters of the left cup holders 70L1 and 70L2 or the right cup holders 70R1 and 70R2.

The holder 80 is, for example, formed as a thin rod. One end of the holder 80 is supported by the left front pillar 28a, and the other end thereof is supported by the right front pillar 28a. The front pillars 28a may support the holder 80 detachably by screwing, or by welding or crimping.

The holder 80 is disposed across the vehicle above the dashboard 50. The holder 80 may be bent or straight. For example, a middle portion 80M of the holder 80 in the vehicle-width direction may be located more rearward than a left portion 80L and a right portion 80R of the holder 80 in the vehicle-width direction in a plan view. Furthermore, the middle portion 80M when viewed from the vehicle rear direction may be located above the left portion 80L and the right portion 80R. In other words, the middle portion 80M is located more rearward than and above the left portion 80L and the right portion 80R. The middle portion 80M may be continuous with the left portion 80L and the right portion 80R through sloped portions or cranks.

The whole holder 80 is located above the left cup holders 70L1 and 70L2 and the right cup holders 70R1 and 70R2. The holder 80 directly or indirectly supports the external apparatus 120. Examples of the external apparatus 110 may include a smart phone and a tablet terminal. The holder 80 supports the external apparatus 120, for example, through a support bracket 122. The support bracket 122 includes, for example, a fixing part 122a and an apparatus setting part 122b. The fixing part 122a may be, for example, a screwing fixing part fixing the external apparatus 120 through screws with the holder 80 being sandwiched, or a spring fixing part sandwiching the external apparatus 120 with the holder 80 through spring elasticity. The apparatus setting part 122b is, for example, a setting part including a bottom supporter that mount supports the external apparatus 120, and a pair of side supporters supporting both sides of the external apparatus 120. Fixing the fixing part 122a of the support bracket 122 at any position of the holder 80 in a longitudinal direction supports the apparatus setting part 122b at any position of the holder 80 in the longitudinal direction. The apparatus setting part 122b may have an attitude facing the head of the occupant, for example, facing diagonally upward and rearward.

Since the whole holder 80 is located above the left cup holders 70L1 and 70L2 and the right cup holders 70R1 and 70R2, the apparatus setting part 122b and the external apparatus 120 supported by the apparatus setting part 122b are also located above the left cup holders 70L1 and 70L2 and the right cup holders 70R1 and 70R2. Even when the liquids spill from the cups 100 held by the left cup holders 70L1 and 70L2 and the right cup holders 70R1 and 70R2, the liquids hardly splash onto the external apparatus 120.

The holder 80 may be located at a position different from those of the left cup holders 70L1 and 70L2 or the right cup holders 70R1 and 70R2 in a plan view. This can make the space above the left cup holders 70L1 and 70L2 or the right cup holders 70R1 and 70R2 open. Thus, the cups 100 are easily attached and detached to and from the left cup holders 70L1 and 70L2 or the right cup holders 70R1 and 70R2.

The holder 80 is preferably more forward than the left cup holders 70L1 and 70L2 or the right cup holders 70R1 and 70R2, in a portion with the left cup holders 70L1 and 70L2 or the right cup holders 70R1 and 70R2 in the vehicle-width direction. In this embodiment, the left portion 80L and the right portion 80R are more forward than the left cup holders 70L1 and 70L2 and the right cup holders 70R1 and 70R2, respectively. Thus, the occupants to be seated behind the left cup holders 70L1 and 70L2 and the right cup holders 70R1 and 70R2 easily attach and detach the cups 100 from diagonally behind the left cup holders 70L1 and 70L2 and the right cup holders 70R1 and 70R2 without any interference with the holder 80.

In the vehicle with the aforementioned structure, the dashboard 50 includes the left cup holders 70L1 and 70L2 located to the left of the middle M in the vehicle-width direction, and the right cup holders 70R1 and 70R2 located to the right of the middle M in the vehicle-width direction. This is convenient because the occupant to be seated to the left of the front seat 24 can use the left cup holders 70L1 and 70L2, and the occupant to be seated to the right of the seat can use the right cup holders 70R1 and 70R2.

For example, if a cup holder is under an information device in the middle, the occupant hardly visually recognizes the cup holder or hardly reaches a cup without trying to reach over the cup forward. The left cup holders 70L1 and 70L2 and the right cup holders 70R1 and 70R2 provided for the left occupant and the right occupant, respectively, allow each of the occupants to use the cup holders 70L1, 70L2, 70R1, and 70R2 in front of the occupant.

If a cup holder is under an information device in the middle, the leg space for the occupants may be squeezed. Furthermore, the cup holder may be an obstacle when the occupant passes inside the vehicle along the vehicle-width direction. The absence of the cup holder under the middle of the dashboard 50 can increase the leg space for the occupants, improves the comfortability, and facilitates the movement of the occupant in the vehicle-width direction.

Since the dashboard 50 further includes the information device 60 between the left cup holders 70L1 and 70L2 and the right cup holders 70R1 and 70R2, the occupants to be seated on the right and left of the seat easily use the information device 60. When the information device 60 is an apparatus including the touch panel 61, the right and left occupants easily view information displayed on the touch panel 61, and easily operate the touch panel 61.

The left cup holders 70L1 and 70L2 or the right cup holders 70R1 and 70R2 provided for each of the occupants increase the convenience of a dedicated item of the occupant, such as a cup filled with a beverage.

Furthermore, the symmetric alignment between the left cup holders 70L1 and 70L2 and the right cup holders 70R1 and 70R2 with respect to the middle M in the vehicle-width direction allows the right and left occupants to easily use the cup holders 70L1, 70L2, 70R1, and 70R2 under the same conditions.

In this case, the left occupant and the right occupant can use the first left cup holder 70L1 and the second left cup holder 70L2 to the left, and the first right cup holder 70R1 and the second right cup holder 70R2 to the right, respectively, which is convenient.

Furthermore, alignment of the first left cup holder 70L1 and the second left cup holder 70L2 in the vehicle-width direction, and alignment of the first right cup holder 70R1 and the second right cup holder 70R2 in the vehicle-width direction allow the right and left occupants to easily and equivalently use the cup holders.

When the left cup holders 70L1 and 70L2 located closer to the steering column 37 among the left cup holders 70L1 and 70L2 and the right cup holders 70R1 and 70R2 are located more outward than the steering column 37 in the vehicle-width direction, the cups 100 held by the left cup holders 70L1 and 70L2 hardly obstruct the line of sight of the driver which is forward and closer to the middle in the vehicle-width direction, and easily maintain the view. Furthermore, the left cup holder 70L1 and 70L2 are accessible from outside in the vehicle-width direction.

Furthermore, the opening perimeters of the left cup holders 70L1 and 70L2 and the right cup holders 70R1 and 70R2 are located above the root 37R of the steering column 37 with respect to the dashboard 50. Thus, the occupants in seated postures visually recognize the left cup holders 70L1 and 70L2 and the right cup holders 70R1 and 70R2 more easily than that when the cup holders are located under the root, and are accessible to and easily use the cup holders 70L1, 70L2, 70R1, and 70R2.

When the opening perimeters of the left cup holders 70L1 and 70L2 and the right cup holders 70R1 and 70R2 are located below the top of the dashboard 50, an upper opening of the cup 100 is easily disposed below the top of the dashboard 50. Consequently, the cup 100 hardly obstructs the front view, and the occupant easily visually recognizes the front.

When the left cup holders 70L1 and 70L2 or the right cup holders 70R1 and 70R2 are disposed in the upper dashboard body 52A, the occupant easily visually recognizes, is accessible to, and easily uses the cup holders 70L1, 70L2, 70R1, and 70R2 more than that when the left cup holders 70L1 and 70L2 or the right cup holders 70R1 and 70R2 are disposed in a lower dashboard.

Furthermore, the support recess 59a supporting the external apparatus 110 in a standing position is more forward than the left cup holders 70L1 and 70L2 or the right cup holders 70R1 and 70R2. For example, when the occupants attach and detach the cups 100 from behind the cup holders 70L1, 70L2, 70R1, and 70R2, even in the case where tilt of the cups 100 causes the liquids to spill from the cups 100, the water hardly splashes onto the support recesses 59a located forward and the external apparatuses 110 supported by the support recesses 59a.

Moreover, the opening perimeter of the support recess 59a is located above the opening perimeters of the left cup holders 70L1 and 70L2 or the right cup holders 70R1 and 70R2. Consequently, the liquids spilling from the cups 100 supported by the left cup holders 70L1 and 70L2 or the right cup holders 70R1 and 70R2 hardly splash onto the external apparatus 110.

Furthermore, the partition wall 58 is located between the support recess 59a and the left cup holders 70L1 and 70L2 or between the support recess 59a and the right cup holders 70R1 and 70R2. Thus, even when the liquids spill from the left cup holders 70L1 and 70L2 or the right cup holders 70R1 and 70R2, the partition wall 58 blocks the liquids, and the liquids hardly splash onto the support recess 59a.

An outside portion of the seat 24 in the vehicle-width direction is opened, and the left cup holders 70L1 and 70L2 or the right cup holders 70R1 and 70R2 are located more rearward than the front pillars 28a, and are opened at positions to be observed from above in a plan view. Thus, the cups 100 can be easily attached and detached from behind while an interference between the front pillars 28a and the cups 100 is reduced.

The dashboard 50 includes the vertical wall 54La and the vertical wall 54Ra located more outward than the openings of the left cup holders 70L1 and 70L2 or the right cup holders 70R1 and 70R, respectively. Here, when the outside portion of the seat 24 in the vehicle-width direction is opened, a foreign substance such as the rainwater or dust may come into the vehicle, for example, onto the dashboard 50. The vertical walls 54La and 54Ra prevent the cups 100 held by the cup holders from receiving the foreign substance.

Furthermore, the sloped portions 54L and 54R that are at least parts of portions enclosing the openings of the left cup holders 70L1 and 70L2 and the right cup holders 70R1 and 70R in the dashboard body 52 include the sloped surfaces 54Lb and 54Rb, respectively, which are lower than the openings and sloped more downward as they extend rearward. Even when the rainwater reaches the sloped surfaces 54Lb and 54Rb around the cup holders 70L1, 70L2, 70R1, and 70R2, the rainwater can be drained under the dashboard 50 and is prevented from entering the cup holders 70L1, 70L2, 70R1, and 70R2.

The recess 70g partially recessed downward is formed around the opening perimeter of each of the left cup holders 70L1 and 70L2 and the right cup holders 70R1 and 70R. When the cups 100 each include the handle 102, the cups 100 can be deeply stored in the cup holders 70L1, 70L2, 70R1, and 70R2 with the handles 102 being placed in the respective recesses 70g, and an amount of protrusion of the upper end of each of the cups 100 from the dashboard 50 can be reduced. Consequently, a better view is easily maintained.

When the recess 70g is located rearward, the handle 102 can be placed rearward. Thus, the occupant is accessible to the handle 102 and can easily attach and detach the cup 100.

Furthermore, the holder 80 detachably holding the external apparatus 120 is located above the opening perimeters of the left cup holders 70L1 and 70L2 or the right cup holders 70R1 and 70R2. Even when the liquids spill from the cups 100 held by the cup holders 70L1, 70L2, 70R1, and 70R2, the liquids hardly splash onto the external apparatus 120 held by the holder 80. The occupant easily visually recognizes the external apparatus 120 above the cup holders 70L1, 70L2, 70R1, and 70R2.

When the holder 80 is located at a position different from those of the left cup holders 70L1 and 70L2 or the right cup holders 70R1 and 70R2 in a plan view, the holder 80 hardly interferes with the occupant in using the cup holders 70L1, 70L2, 70R1, and 70R2.

This application discloses the following aspects.

A vehicle according to a first aspect includes: a car body; wheels rotatably supported by the car body; a steering wheel steering the wheels; a seat more rearward than the steering wheel; and a dashboard including a dashboard body, a left cup holder, and a right cup holder, the dashboard body being more forward than the seat, the left cup holder being located to the left of a middle in a vehicle-width direction, the right cup holder being located to the right of the middle in the vehicle-width direction.

In this vehicle, the occupant to be seated to the left of the seat can use the left cup holder in front of the seat, and the occupant to be seated to the right of the seat can use the right cup holder in front of the seat, which is convenient.

A vehicle according to a second aspect is the vehicle according to the first aspect, wherein the dashboard further includes an information device located between the left cup holder and the right cup holder.

In this case, the information device is disposed in the middle of the dashboard in the vehicle-width direction. Not only the occupant to be seated to the left of the seat but also the occupant to be seated to the right of the seat easily uses the information device. The right cup holder is disposed to the right of the information device, and the left cup holder is disposed to the left thereof. Thus, the occupants easily use the respective cup holders.

A third aspect is the vehicle according to the second aspect, wherein the information device includes a touch panel that displays information and receives a touch operation.

This allows the touch panel in the middle of the dashboard in the vehicle-width direction to display the information and receive the touch operation.

A fourth aspect is the vehicle according to one of the first to third aspects, wherein the left cup holder is in symmetric alignment with the right cup holder with respect to the middle in the vehicle-width direction.

In this case, the right and left occupants easily use cup holders under the same conditions.

A fifth aspect is the vehicle according to one of the first to fourth aspects, the vehicle further includes a steering column supporting the steering wheel on one side in the vehicle-width direction, wherein the left cup holder or the right cup holder on the one side in the vehicle-width direction is located more outward than the steering column in the vehicle-width direction.

Consequently, a view is easily maintained.

A sixth aspect is the vehicle according to one of the first to fifth aspects, and the vehicle further includes a steering column supporting the steering wheel, wherein opening: perimeters of the left cup holder and the right cup holder are located above a root of the steering column with respect to the dashboard.

Consequently, the occupants easily use the cup holders.

A seventh aspect is the vehicle according to one of the first to sixth aspects, wherein opening perimeters of the left cup holder and the right cup holder are located below a top of the dashboard.

Consequently, the occupants easily visually recognize the forward view.

An eighth aspect is the vehicle according to one of the first to seventh aspects, wherein the dashboard body includes an upper dashboard body, and a lower dashboard body under the upper dashboard body, and the upper dashboard body includes the left cup holder or the right cup holder.

Since the upper dashboard body includes the left cup holder or the right cup holder, the occupant easily uses the cup holder.

A ninth aspect is the vehicle according to one of the first to eighth aspects, wherein the dashboard body includes a support recess supporting an external apparatus in a standing position, the support recess being more forward than the left cup holder or the right cup holder.

Consequently, a smart phone can be supported in a standing position and more forward than the left cup holder or the right cup holder. When the cup holder is used, the liquid hardly splashes onto the external apparatus.

A tenth aspect is the vehicle according to the ninth aspect, wherein an opening perimeter of the support recess is located above an opening perimeter of the left cup holder or the right cup holder.

Since the opening perimeter of the support recess is located above the opening perimeter of the left cup holder or the right cup holder, the liquid spilling from the cup supported by the cup holder hardly splashes onto the external apparatus.

An eleventh aspect is the vehicle according to one of the ninth and tenth aspects, wherein a partition wall is located between the support recess and the left cup holder or the right cup holder.

Consequently, the partition wall prevents the liquid spilling from the cup supported by the cup holder from splashing onto the external apparatus.

A twelfth aspect is the vehicle according to one of the first to eleventh aspects, wherein the left cup holder or the right cup holder may include a recess partially recessed downward from an opening perimeter of the left cup holder or the right cup holder.

Even when a cup includes a handle, the cup can be deeply stored in the cup holder, and an amount of protrusion of the upper end of the cup from the dashboard can be reduced. Consequently, a better view is easily maintained.

A thirteenth aspect is the vehicle according to the twelfth aspect, wherein the recess is located rearward in the opening perimeter of the left cup holder or the right cup holder.

Since the handle of the cup can be disposed rearward, the occupant is accessible to the handle.

A fourteenth aspect is the vehicle according to one of the first to thirteenth aspects, and the vehicle includes a holder detachably holding an external apparatus above an opening perimeter of the left cup holder or the right cup holder.

Even when the liquid spills from the cup held by the cup holder, the liquid hardly splashes onto the external apparatus held by the holder. Furthermore, the occupant easily visually recognizes the external apparatus.

A fifteenth aspect is the vehicle according to the fourteenth aspect, wherein the holder is located at a position different from a position of the left cup holder or the right cup holder in a plan view.

When the occupant uses the cup holder, a holding bar hardly interferes with the occupant.

A sixteenth aspect is the vehicle according to one of the first to fifteenth aspects, wherein the left cup holder includes a first left cup holder and a second left cup holder, and the right cup holder includes a first right cup holder and a second right cup holder.

Thus, the right and left occupants can use the respective cup holders, which is convenient.

A seventeenth aspect is the vehicle according to the sixteenth aspect, wherein the first left cup holder and the second left cup holder are aligned in the vehicle-width direction, and the first right cup holder and the second right cup holder are aligned in the vehicle-width direction.

Thus, the right and left occupants easily and equivalently use the respective cup holders.

An eighteenth aspect is the vehicle according to one of the first to seventeenth aspects, and the vehicle further includes front pillars, wherein an outside portion of the seat in the vehicle-width direction is opened, and the left cup holder or the right cup holder is located more rearward than the front pillars, and is opened at a position to be observed from above in a plan view.

Consequently, a cup can be attached and detached while an interference between the cup and the pillars is prevented.

A nineteenth aspect is the vehicle according to one of the first to eighteenth aspects, wherein an outside portion of the seat in the vehicle-width direction is opened, and the dashboard includes a vertical wall located more outward than an opening of the left cup holder or the right cup holder in the vehicle-width direction, the vertical wall protruding more upward than the opening.

When the outside portion of the seat in the vehicle-width direction is opened, a foreign substance such as the rainwater or dust may come into the vehicle from outside in the vehicle-width direction. The vertical wall prevents the cup held by the cup holder from receiving the foreign substance.

A tenth aspect is the vehicle according to one of the first to nineteenth aspects, wherein an outside portion of the seat in the vehicle-width direction is opened, and at least a part of a portion enclosing an opening of the left cup holder or the right cup holder of the dashboard is a sloped surface lower than the opening and sloped more downward as the sloped surface extends rearward.

Even when the rainwater reaches the sloped surface around the cup holder, the rainwater can be drained under the dashboard and is prevented from entering the cup holder.

The foregoing description is in all aspects illustrative and does not restrict the present invention. Numerous modifications and variations that have not yet been exemplified are devised without departing from the scope of the present invention.

1. A vehicle, comprising:
a car body;
wheels rotatably supported by the car body;
a steering wheel steering the wheels;
a seat more rearward than the steering wheel; and
a dashboard including a dashboard body, a left cup holder, and a right cup holder, the dashboard body being more forward than the seat, the left cup holder being located to the left of a middle in a vehicle-width direction, the right cup holder being located to the right of the middle in the vehicle-width direction.

2. The vehicle according to claim 1,
wherein the dashboard further includes an information device located between the left cup holder and the right cup holder.

3. The vehicle according to claim 2,
wherein the information device includes a touch panel that displays information and receives a touch operation.

4. The vehicle according to claim 1,
wherein the left cup holder is in symmetric alignment with the right cup holder with respect to the middle in the vehicle-width direction.

5. The vehicle according to claim 1, further comprising
a steering column supporting the steering wheel on one side in the vehicle-width direction,
wherein the left cup holder or the right cup holder on the one side in the vehicle-width direction is located more outward than the steering column in the vehicle-width direction.

6. The vehicle according to claim 1, further comprising
a steering column supporting the steering wheel,
wherein opening perimeters of the left cup holder and the right cup holder are located above a root of the steering column with respect to the dashboard.

7. The vehicle according to claim 1,
wherein opening perimeters of the left cup holder and the right cup holder are located below a top of the dashboard.

8. The vehicle according to claim 1,
wherein the dashboard body includes an upper dashboard body, and a lower dashboard body under the upper dashboard body, and
the upper dashboard body includes the left cup holder or the right cup holder.

9. The vehicle according to claim 1,
wherein the dashboard body includes a support recess supporting an external apparatus in a standing position, the support recess being more forward than the left cup holder or the right cup holder.

10. The vehicle according to claim 9,
wherein an opening perimeter of the support recess is located above an opening perimeter of the left cup holder or the right cup holder.

11. The vehicle according to claim 9,
wherein a partition wall is located between the support recess and the left cup holder or the right cup holder.

12. The vehicle according to claim 1,
wherein the left cup holder or the right cup holder includes a recess partially recessed downward from an opening perimeter of the left cup holder or the right cup holder.

13. The vehicle according to claim 12,
wherein the recess is located rearward in the opening perimeter of the left cup holder or the right cup holder.

14. The vehicle according to claim 1, further comprising
a holder detachably holding an external apparatus above an opening perimeter of the left cup holder or the right cup holder.

15. The vehicle according to claim 14,
wherein the holder is located at a position different from a position of the left cup holder or the right cup holder in a plan view.

16. The vehicle according to claim 1,
wherein the left cup holder includes a first left cup holder and a second left cup holder, and
the right cup holder includes a first right cup holder and a second right cup holder.

17. The vehicle according to claim 16,
wherein the first left cup holder and the second left cup holder are aligned in the vehicle-width direction, and
the first right cup holder and the second right cup holder are aligned in the vehicle-width direction.

18. The vehicle according to claim 1, further comprising
front pillars,
wherein an outside portion of the seat in the vehicle-width direction is opened, and
the left cup holder or the right cup holder is located more rearward than the front pillars, and is opened at a position to be observed from above in a plan view.

19. The vehicle according to claim 1,
wherein an outside portion of the seat in the vehicle-width direction is opened, and
the dashboard includes a vertical wall located more outward than an opening of the left cup holder or the right cup holder in the vehicle-width direction, the vertical wall protruding more upward than the opening.

20. The vehicle according to claim 1,
wherein an outside portion of the seat in the vehicle-width direction is opened, and
at least a part of a portion enclosing an opening of the left cup holder or the right cup holder of the dashboard is a sloped surface lower than the opening and sloped more downward as the sloped surface extends rearward.
